(19) United States
(12) Patent Application Publication
(10) Pub. No.: US 2022/0403088 A1
(43) Pub. Date: Dec. 22, 2022

(54) HYDROXY-TERMINATED POLYURETHANE PREPOLYMER HAVING LOW ALLOPHANATE CONTENT

(71) Applicant: Covestro Intellectual Property GmbH & Co. KG, Leverkusen (DE)

(72) Inventors: Thomas Koenig, Leverkusen (DE); Mathias MATNER, Neuss (DE); Bernd GARSKA, Köln (DE); Rainer BELLINGHAUSEN, Odenthal (DE); Claudia HOUBEN, Heinsberg (DE); Stephan SCHUBERT, Leverkusen (DE)

(21) Appl. No.: 17/781,132

(22) PCT Filed: Dec. 10, 2020
(86) PCT No.: PCT/EP2020/085520

§ 371 Date: May 31, 2022

(30) Foreign Application Priority Data
Dec. 17, 2019 (EP) 19216788.0

(51) Int. Cl. C08G 18/08; C08G 18/10; C08G 18/73; C08G 18/32

(52) U.S. Cl. CPC C08G 18/0895; C08G 18/10; C08G 18/73; C08G 18/3206

(57) ABSTRACT

The present invention relates to hydroxy-terminated polyurethane prepolymers that consist to an extent of at least 90% by weight of the product of the reaction of hexamethylene 1,6-diisocyanate with butane-1,4-diol and have an allophanate content of ≤1.00 mol %, to a process for the production thereof, to compositions comprising such polyurethane prepolymers and to the use of said polyurethane prepolymers.

The present invention relates to hydroxy-terminated polyurethane prepolymers that consist to an extent of at least 90% by weight of the product of the reaction of hexamethylene 1,6-diisocyanate with butane-1,4-diol and have an allophanate content of ≤1.00 mol %, to a process for the production thereof, to compositions comprising such polyurethane prepolymers and to the use of said polyurethane prepolymers.

Polyurethane prepolymers are important components in polyurethane chemistry. As hydroxy-terminated prepolymers, they are used as OH components in combination with polyisocyanates for example in two-component coating or adhesive systems. Typical fields of use are adhesives for the packaging industry or systems for coating leather or textiles (Kunststoff Handbuch [Plastics Handbook] volume 7, Polyurethane [Polyurethanes], G. Oertel, Hanser Verlag, pp. 99 ff).

Thermoplastic aliphatic polyurethane prepolymers formed from short-chain aliphatic diols and aliphatic polyisocyanates have useful properties. As hard-segment structural units, they are eminently suitable for the modification of a diversity of products and materials. Thermoplastic polyurethane prepolymers that have a low content of allophanate groups compared to comparable thermoplastic polyurethane prepolymers with a higher allophanate content are particularly sought after, since allophanates lower the crystallinity of the hard segments. In addition, allophanates result in branching, which lowers the flowability of polyurethane prepolymers.

JP4209619A and JP4309516A disclose thermoplastic polyurethane resin compositions having a low allophanate content. The polyurethanes have both hard and soft segments. Pure hard-segment polyurethanes or polyurethane prepolymers, in particular ones formed solely from aliphatic reactants, are not described.

JP2010001332A discloses aqueous polyurethane resin dispersions having a low allophanate content. The polyurethanes have both hard and soft segments. Pure hard-segment polyurethanes or polyurethane prepolymers, in particular ones formed solely from aliphatic reactants, are not described.

A problem in the production of aliphatic polyurethane prepolymers is that the high density of reactive groups means that the polyaddition of short-chain aliphatic diols with aliphatic polyisocyanates has a high heat/enthalpy of reaction that, if inadequately dissipated, results in damage, for example discoloration, up to and including reformation of the monomers and destruction (ashing) of the polyurethane prepolymers. An increased reaction temperature also catalyses unwanted allophanate formation. This results in branched and crosslinked polymers.

In industrial practice, preference is given to continuous production processes, since they make it easier to scale up production and allow greater amounts to be produced with constant quality. The use of solvents is likewise disadvantageous, since residual solvents remaining in the product may be released into its surroundings, causing unwanted properties such as odour, toxicity and/or a deterioration in mechanical properties. The complete removal of residual solvents from a polymer is intrinsically associated with an increase in technical complexity and in energy consumption.

DE 10 2011 085 944 A1 describes a process for producing a low-melting-point thermoplastic polyurethane in a loop reactor. The high reaction temperatures needed for the process promote the formation of allophanates and make it difficult or impossible to dissipate the heat evolved in reactions that are highly exothermic.

A process for producing polyurethane is disclosed for example in WO01/14441. This discloses a process for producing NCO—, NH— or OH-terminated polyurethanes in a static mixer. Key to this process is that the temperature during the reaction of the components is controlled adiabatically and/or that the static mixer is trace heated, consequently it is suitable only for processes that are endothermic or have only low exothermicity. The process is unsuitable for the reaction of components having a high enthalpy of reaction, i.e. components that react together strongly exothermically.

A disadvantage of the processes described above is that they are suitable primarily for reactions that are either endothermic or have only a low heat of reaction and therefore require a constant input of heat or must be controlled adiabatically. In systems that have a high exothermicity of reaction (≤−350 kJ/kg), the adiabatic temperature rise is problematic. Starting from monomers at a temperature sufficient for uncatalysed initiation of the reaction (>50° C.), the temperature of the reaction products would rise to well above 300° C. in adiabatic mode. The production and processing of polyurethanes at temperatures of >200° C. over longer periods is problematic on account of a multitude of thermal side reactions. A temperature of 300° C. is moreover above the ceiling temperature of the polyurethane bond. The ceiling temperature is defined as the temperature at which depolymerization is in equilibrium with polymerization.

It is an object of the present invention to provide a hydroxy-terminated polyurethane prepolymer formed from at least 90% by weight of aliphatic structural units and having a lower allophanate content than a comparable aliphatic polyurethane prepolymer, and a process for the production thereof.

This object is achieved by a hydroxy-terminated polyurethane prepolymer, characterized in that the hydroxy-terminated polyurethane prepolymer consists to an extent of at least 90% by weight of the product of the reaction of hexamethylene 1,6-diisocyanate with butane-1,4-diol, based on the total mass of the hydroxy-terminated polyurethane prepolymer, and that the allophanate content of the hydroxy-terminated polyurethane prepolymer is ≤1.00 mol % based on the sum total of all urethane and allophanate groups in the hydroxy-terminated polyurethane prepolymer, in each case determined by NMR spectroscopy.

It was surprisingly found that the hydroxy-terminated prepolymers of the invention have a considerably lower allophanate content than comparable hydroxy-terminated polyurethane prepolymers produced by a conventional batch process. The low content of allophanates results in a less pronounced reduction in the crystallinity of hard segments. The low allophanate content also results in less branching, which lowers the flowability of the polyurethane prepolymers.

In the context of the present invention, the word “a” in connection with countable parameters is to be understood as meaning the number “one” only when this is stated explicitly (for instance by the expression “precisely one”). Where reference is made hereinbelow to for example “a polyol”, the word “a” is to be understood as meaning merely the indefinite article and not the number “one”; an embodiment comprising a mixture of at least two diols is therefore also covered by this.

According to the invention, the terms “comprising” or “containing” preferably mean “consisting essentially of” and more preferably mean “consisting of”.

The allophanate concentration was determined by ¹H NMR spectroscopy (instrument: Bruker AV III HD 600, at a measurement frequency of 600.36 MHz, using the zg30 pulse program, with 64 scans, a relaxation delay (D1) of 6 s and TE of 354 K). For this, a sample of the polyurethane prepolymer was dissolved in deuterated dimethyl sulfoxide (DMSO-d₆) at 80° C. and then measured. Spectra were evaluated using the MestReNova software. Firstly, a baseline correction (Whittaker smoother) was applied, which was followed by integration of the allophanate-specific protons of the CH₂ group between 3.56 ppm and 3.66 ppm and of the urethane-specific protons of the O—CH₂ group between 3.84 ppm and 4.04 ppm. The sum of the two integrals was then calculated and used to determine the proportion by percent of the allophanate signal, which corresponds to the molar proportion of the allophanate groups.

Unless explicitly stated otherwise, in the present invention, the centrifuge-average molar mass M̅_{z′}, the mass-average molar mass M̅_{w} and the number-average molar mass M̅ₙ are determined by gel-permeation chromatography (GPC) using polymethyl methacrylate as standard. The sample to be analyzed is dissolved in a solution of 3 g of potassium trifluoroacetate in 400 cubic centimetres of hexafluoroisopropanol (sample concentration about 2 mg/cubic centimetre), then applied via a pre-column at a flow rate of 1 cubic centimetre/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column The detector used was a refractive index detector (RI detector).

The centrifuge-average molar mass (M̅_{z}) was calculated from the data obtained by the gel-permeation chromatography measurement with the aid of the following equation:

$${\overline{M}}_{z} = \frac{{\sum }_{i} {n}_{i} {M}_{i}^{3}}{{\sum }_{i} {n}_{i} {M}_{i}^{2}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

The mass-average molar mass (M̅_{w}) was likewise calculated from the data obtained by the gel-permeation chromatography measurement with the aid of the following equation:

$${\overline{M}}_{w} = \frac{{\sum }_{i} {n}_{i} {M}_{i}^{2}}{{\sum }_{i} {n}_{i} {M}_{i}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

The number-average molar mass (M̅ₙ) was likewise calculated from the data obtained by the gel-permeation chromatography measurement with the aid of the following equation:

$${\overline{M}}_{n} = \frac{{\sum }_{i} {n}_{i} {M}_{i}}{{\sum }_{i} {n}_{i}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

Unless stated explicitly otherwise, melting points were determined by DSC (differential scanning calorimetry) using a DSC 8500 (PerkinElmer, USA) in accordance with DIN-EN-ISO 11357-1.

Calibration was effected via the melt onset temperature of octane, indium, lead and zinc. About 10 mg of substance was weighed into aluminium crucibles. The measurement was effected by two heating runs from −20° C. to +210° C. at a heating rate of 20 K/min with subsequent cooling at a cooling rate of 20 K/min. Cooling was effected by a compressor cooler. The purge gas used was nitrogen. The values reported are each based on evaluation of the 2nd heating curve.

A preferred embodiment relates to a hydroxy-terminated polyurethane prepolymer obtained or obtainable by the reaction of at least hexamethylene 1,6-diisocyanate with butane-1,4-diol, optionally in the presence of a catalyst and/or auxiliaries and additives, the molar NCO/OH ratio being within a range from 0.6:1.0 to 0.95:1.0, the reaction preferably being carried out in a loop reactor or in a static mixer, the loop reactor or static mixer preferably having at least one heat-transfer unit that continuously conducts away heat, the heat that is conducted away preferably amounting to from 10% to 90%, more preferably from 20% to 70%, particularly preferably from 25% to 60%, of the total enthalpy of reaction released in the tubular reactor, characterized in that the hydroxy-terminated polyurethane prepolymer consists to an extent of at least 90% by weight of the product of the reaction of hexamethylene 1,6-diisocyanate with butane-1,4-diol, based on the total mass of the hydroxy-terminated polyurethane prepolymer, and that the allophanate content of the hydroxy-terminated polyurethane prepolymer is ≤1.00 mol % based on the sum total of all urethane and allophanate groups in the hydroxy-terminated polyurethane prepolymer, in each case determined by NMR spectroscopy.

In a preferred embodiment, the hydroxy-terminated polyurethane prepolymer is produced in a continuous process, in particular the reaction of at least hexamethylene 1,6-diisocyanate with butane-1,4-diol is carried out in a loop reactor or in a static mixer.

A preferred embodiment relates to a hydroxy-terminated polyurethane prepolymer obtained or obtainable by the reaction of at least hexamethylene 1,6-diisocyanate with butane-1,4-diol, optionally in the presence of a catalyst and/or auxiliaries and additives, the molar NCO/OH ratio being within a range from 0.6:1.0 to 0.95:1.0, in a process comprising the steps:

a) producing a mixture of a portion of the hexamethylene diisocyanate (HDI) and the totality of the butanediol (BDO);

b) mixing the mixture produced in process step a) with an oligomer partial output stream obtained in process step e);

c) bringing the mixture from process step b) to reaction;

d) splitting the reaction mixture obtained in step c) into two partial output streams;

e) feeding back a partial output stream from process step d) as a partial input stream for the mixture in process step b);

f) discharging the remaining partial output stream from process step d) comprising the hydroxy-terminated polyurethane prepolymer, characterized in that the hydroxy-terminated polyurethane prepolymer consists to an extent of at least 90% by weight of the product of the reaction of hexamethylene 1,6-diisocyanate with butane-1,4-diol, based on the total mass of the hydroxy-terminated polyurethane prepolymer, and that the allophanate content of the hydroxy-terminated polyurethane prepolymer is ≤1.00 mol % based on the sum total of all urethane and allophanate groups in the hydroxy-terminated polyurethane prepolymer, in each case determined by NMR spectroscopy.

In a preferred embodiment, the hydroxy-terminated polyurethane prepolymer is produced in a continuous process, in particular the reaction of at least hexamethylene 1,6-diisocyanate with butane-1,4-diol is carried out in a loop reactor, the loop reactor having at least one heat-transfer unit that continuously conducts away heat, the heat that is conducted away preferably amounting to from 10% to 90%, more preferably from 20% to 70%, particularly preferably from 25% to 60%, of the total enthalpy of reaction released in the loop reactor.

A further object of the invention relates to a hydroxy -terminated polyurethane prepolymer obtained or obtainable by the reaction of at least hexamethylene 1,6-diisocyanate with butane-1,4-diol, optionally in the presence of a catalyst and/or auxiliaries and additives, in a process comprising the steps:

a) mixing a polyisocyanate stream (A) and a polyol stream (B) in a first mixing unit (7) to obtain a mixed stream (C), the mass flows of the polyisocyanate stream (A) and a polyol stream (B) being adjusted such that the molar ratio of isocyanate to hydroxy groups in mixed stream (C) is within a range from 0.6:1.0 to 0.95:1.0,

b) introducing the mixed stream (C) into a circulation stream (D) that is circulated, wherein the monomers of the polyisocyanate stream (A) and of the polyol stream (B) react further in the circulation stream (D) to form prepolymers, preferably hydroxy-terminated prepolymers,

c) diverting a substream of the circulation stream (D) as a prepolymer stream (E) comprising the thermoplastic aliphatic polyurethane prepolymer,

d) optionally extruding the prepolymer stream (E),

characterized in that the hydroxy-terminated polyurethane prepolymer consists to an extent of at least 90% by weight of the product of the reaction of hexamethylene 1,6-diisocyanate with butane-1,4-diol, based on the total mass of the hydroxy-terminated polyurethane prepolymer, and that the allophanate content of the hydroxy-terminated polyurethane prepolymer is ≤1.00 mol % based on the sum total of all urethane and allophanate groups in the hydroxy-terminated polyurethane prepolymer, in each case determined by NMR spectroscopy.

In a preferred embodiment, the hydroxy-terminated polyurethane prepolymer is produced in a continuous process, in particular the reaction of at least hexamethylene 1,6-diisocyanate with butane-1,4-diol is carried out in a loop reactor, the loop reactor having at least one heat-transfer unit that continuously conducts away heat, the heat that is conducted away preferably amounting to from 10% to 90%, more preferably from 20% to 70%, particularly preferably from 25% to 60%, of the total enthalpy of reaction released in the loop reactor.

In a preferred embodiment, the average degree of polymerization n of the hydroxy-terminated polyurethane prepolymer of the invention is within a range from 1.5 to 19, preferably within a range from 2 to 9 and more preferably within a range from 3.2 to 6, the average degree of polymerization being

$$n = \frac{x}{1 - x} ,$$

where x is the ratio of the NCO groups in the polyisocyanate monomers to hydroxy groups in the polyol monomers, in particular where x is the ratio of the NCO groups in the polyisocyanate monomers used to the hydroxy groups in the polyol monomers used.

The aliphatic polyisocyanate monomers used are preferably 1,4-diisocyanatobutane (BDI), 1,5-diisocyanatopentane (PDI), 1,6-diisocyanatohexane (HDI) or a mixture of at least two of these, more preferably 1,6-diisocyanatohexane (HDI).

The aliphatic polyol monomers used are preferably propane-1,3-diol, butane-1,4-diol, hexane-1,6-diol and/or mixtures of at least two of these, more preferably butane-1,4-diol. Preference is given to using no branched polyol monomers.

In a preferred embodiment, the hydroxy-terminated polyurethane prepolymer of the invention consists to an extent of at least 96% by weight, preferably to an extent of at least 97% by weight, more preferably to an extent of at least 98% by weight, even more preferably to an extent of at least 99% by weight, even more preferably still to an extent of at least 99.5% by weight and most preferably to an extent of at least 99.9% by weight of the product of the reaction of hexamethylene 1,6-diisocyanate with butane-1,4-diol, based on the total mass of the hydroxy-terminated polyurethane prepolymer. When determining the proportion of the product of the reaction of hexamethylene 1,6-diisocyanate with butane-1,4-diol, only the polymeric constituents are taken into account, based on the total mass of the polymeric thermoplastic aliphatic polyurethane prepolymer.

In a preferred embodiment, the allophanate content of the hydroxy-terminated polyurethane prepolymer of the invention is within a range from 0.25 mol % to 1.00 mol %, preferably within a range from 0.25 mol % to 0.80 mol %, more preferably within a range from 0.30 mol % to 0.80 mol %, even more preferably within a range from 0.30 mol % to 0.75 mol %, even more preferably still within a range from 0.34 mol % to 0.70 mol %, based on the sum total of all urethane and allophanate groups in the hydroxy-terminated polyurethane prepolymer, determined by NMR spectroscopy.

In a preferred embodiment, the thermoplastic aliphatic polyurethane prepolymer of the invention has an average OH functionality, calculated from the functionalities of the monomers, of 1.8 to 2.1, preferably 1.95 to 2.05, more preferably 1.97 to 2.0, most preferably 1.975 to 2.0.

In a preferred embodiment, the ratio M̅_{w}/M̅ₙ of the hydroxy-terminated polyurethane prepolymer of the invention is within a range from 2 to 20, preferably within a range from 2.5 to 15, more preferably within a range from 4 to 10, where M̅ₙ is the number-average molar mass and M̅_{w} the mass-average molar mass, in each case determined by gel-permeation chromatography, the sample being dissolved in a solution of potassium trifluoroacetate in hexafluoroisopropanol having a concentration of 2 mg/cm³ and using a polymethyl methacrylate standard.

In a further preferred embodiment, the ratio M̅_{z}/M̅_{w} of the hydroxy-terminated polyurethane prepolymer of the invention is within a range from 2.3 to 5, preferably within a range from 2.3 to 4, where M̅_{z} is the centrifuge-average molar mass and M̅_{w} the mass-average molar mass, in each case determined by gel-permeation chromatography, the sample being dissolved in a solution of potassium trifluoroacetate in hexafluoroisopropanol having a concentration of 2 mg/cm³ and using a polymethyl methacrylate standard.

In a further preferred embodiment, the hydroxy-terminated polyurethane prepolymer of the invention has a melting point of >150° C., preferably a melting point of >160° C., more preferably a melting point within a range from 165° C. to 190° C., determined by differential scanning calorimetry in accordance with DIN EN 61006 (November 2004).

A further object of the invention relates to a process for producing a hydroxy-terminated polyurethane prepolymer of the invention, characterized in that at least hexamethylene 1,6-diisocyanate is reacted with butane-1,4-diol, optionally in the presence of a catalyst and/or auxiliaries and additives, the molar NCO/OH ratio being within a range from 0.6:1.0 to 0.95:1.0.

In addition to hexamethylene 1,6-diisocyanate, it is also possible to use one or more other polyisocyanates, for example aromatic polyisocyanates, cycloaliphatic polyisocyanates and/or araliphatic polyisocyanates. More particularly, in addition to hexamethylene 1,6-diisocyanate, one or more aliphatic polyisocyanates are used that are different to hexamethylene 1,6-diisocyanate.

Suitable aliphatic polyisocyanates are all aliphatic polyisocyanates known to those skilled in the art, in particular monomeric aliphatic diisocyanates. Suitable compounds are preferably those in the molecular weight range from ≥140 g/mol to ≤400 g/mol, irrespective of whether these have been obtained by phosgenation or by phosgene-free methods. The polyisocyanates and/or precursor compounds thereof may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation.

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

In the context of the present invention, the term “monomeric diisocyanate” is understood as meaning a diisocyanate that includes no dimeric, trimeric, etc. structures, is part of dimeric, trimeric, etc. structures, and/or a product of the reaction of an NCO group with an NCO-reactive group, for example urethane, urea, carbodiimide, acylurea, amide, isocyanurate, allophanate, biuret, oxadiazinetrione, uretdione and/or iminooxadiazinedione structures.

In a preferred embodiment, one or more aliphatic polyisocyanates used in addition to hexamethylene 1,6-diisocyanate are selected from the group consisting of 1,4-diisocyanatobutane, 1,5-diisocyanatopentane, 2-methyl-1,5-diisocyanatopentane and/or mixtures of at least two of these. In another preferred embodiment, 1,5-diisocyanatopentane and/or 1,6-diisocyanatohexane are used as aliphatic polyisocyanates. In a further preferred embodiment, solely 1,6-diisocyanatohexane is used.

In addition to butane-1,4-diol, one or more further polyols may be used. More particularly, in addition to butane-1,4-diol, one or more aliphatic polyols may be used that are different to butane-1,4-diol and have a molecular weight within a range from 62 g/mol to 210 g/mol, preferably within a range from 62 g/mol to 120 g/mol.

Suitable as further aliphatic polyols are all organic diols known to those skilled in the art that have a molecular weight within a range from 62 g/mol to 210 g/mol, preferably diols that have a molecular weight within a range from 62 g/mol to 120 g/mol. The diols and/or the precursor compounds thereof may have been obtained from fossil or biological sources. The aliphatic diols for formation of the thermoplastic polyurethane polymer of the invention are preferably selected from the group consisting of ethane-1,2-diol, propane-1,2-diol, propane-1,3-diol, butane-1,2-diol, butane-1,3-diol, pentane-1,2-diol, pentane-1,3-diol, pentane-1,4-diol, pentane-1,5-diol, hexane-1,2-diol, hexane-1,3-diol, hexane-1,4-diol, hexane-1,5-diol, hexane-1,6-diol or mixtures of at least two of these. Preference is given to using no branched aliphatic diols.

In a preferred embodiment, the further aliphatic diols are selected from the group consisting of ethane-1,2-diol, propane-1,2-diol, propane-1,3-diol, butane-1,2-diol, butane-1,3-diol, pentane-1,5-diol, hexane-1,6-diol and/or mixtures of at least two of these. In a further preferred embodiment, propane-1,3-diol, hexane-1,6-diol and/or mixtures thereof are used as further aliphatic diols. In another preferred embodiment, solely butane-1,4-diol is used as aliphatic diol.

The reaction of the co-reactants to form the thermoplastic aliphatic polyurethane prepolymer of the invention can take place in the presence of one or more catalysts.

Suitable catalysts according to the invention are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo [2.2.2]octane and the like, and also in particular organic metal compounds such as titanic esters, iron compounds, tin compounds, e.g. tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds and/or tin compounds.

The catalyst is used in amounts of 0.001% by weight to 2.0% by weight, preferably of 0.005% by weight to 1.0% by weight, more preferably of 0.01% by weight to 0.1% by weight, based on the diisocyanate component. The catalyst can be used in neat form or dissolved in the diol component. This has the advantage that the thermoplastic polyurethanes that are then obtained do not contain any impurities as a result of any catalyst solvents additionally used. The catalyst can be added in one or more portions or else continuously, for example with the aid of a suitable metering pump, over the entire duration of the reaction.

Alternatively, it is also possible to use mixtures of the catalyst(s) with a catalyst solvent, preferably with an organic catalyst solvent. The degree of dilution of the catalyst solutions can be chosen freely within a very wide range. Catalytically active solutions are those having a concentration of 0.001% by weight and above.

Suitable solvents for the catalyst are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl ether acetate, ethylene glycol monoethyl ether acetate, diethylene glycol ethyl ether acetate, diethylene glycol butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

Alternatively, it is possible to use solvents for the catalyst that bear groups reactive toward isocyanates and can be incorporated into the diisocyanate. Examples of such solvents are mono- or polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher-molecular-weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

Auxiliaries and additives used may for example be standard auxiliaries and additives in the field of thermoplastics technology, such as dyes, fillers, processing auxiliaries, plasticizers, nucleating agents, stabilizers, flame retardants, demoulding agents or reinforcing auxiliaries and additives. Further details on the auxiliaries and additives mentioned may be found in the specialist literature, for example in the monograph by J. H. Saunders and K. C. Frisch “High Polymers”, volume XVI, Polyurethane [Polyurethanes], parts 1 and 2, Interscience Publishers 1962 and 1964, in “Taschenbuch für Kunststoff-Additive” [Plastics Additives Handbook] by R. Gächter and H. Müller (Hanser Verlag Munich 1990) or in DE-A 29 01 774. It will be self-evident that it can likewise be advantageous to use a plurality of auxiliaries and additives of a plurality of types.

The process of the invention may be carried out in a loop reactor or in a mixer, for example in a static mixer. The process of the invention may preferably be carried out in a loop reactor. The process of the invention is preferably a continuous process.

The thermoplastic aliphatic polyurethane prepolymer of the invention that is obtained or obtainable from the process of the invention may further contain unreacted monomers or be present in addition thereto in the process product. This happens, for example, when a monomer, for example the diol component, is used in excess. The amount of unreacted monomers is preferably within a range from 0.05% by weight to 12% by weight, more preferably within a range from 0.35% by weight to 9% by weight, particularly preferably within a range from 0.75% by weight to 6% by weight, in each case based on the total mass of the composition.

In a preferred embodiment of the process of the invention, the reaction is carried out in a tubular reactor, preferably in a loop reactor or in a static mixer, the tubular reactor having at least one heat-transfer unit that continuously conducts away heat, the heat that is conducted away preferably amounting to from 10% to 90%, more preferably from 20% to 70%, particularly preferably from 25% to 60%, of the total enthalpy of reaction released in the tubular reactor.

In a preferred embodiment of the process of the invention, the process is solvent-free.

In a preferred embodiment of the process of the invention, the process is a continuous process.

A further object of the invention relates to a composition comprising at least one hydroxy-terminated polyurethane prepolymer of the invention and at least one polyol, preferably a diol, more preferably butanediol, particularly preferably butane-1,4-diol.

A preferred embodiment of the invention relates to a composition comprising at least one hydroxy-terminated polyurethane prepolymer of the invention and butane-1,4-diol, the amount of butane-1,4-diol in the composition being preferably within a range from 0.05% by weight to 12% by weight, more preferably within a range from 0.35% by weight to 9% by weight, particularly preferably within a range from 0.75% by weight to 6% by weight, in each case based on the total mass of the composition.

A further preferred embodiment of the invention relates to a composition comprising at least one hydroxy-terminated polyurethane prepolymer of the invention and at least one additive. Suitable as additives are all additives and auxiliaries mentioned above.

A further object of the invention relates to the use of a hydroxy-terminated polyurethane prepolymer of the invention or of a composition of the invention for the production of thermoplastic polyurethane and/or thermoplastic polyurethane dispersions, in particular for the production of thermoplastic polyurethane.

A further object of the invention relates to a polymer obtainable by the reaction of at least one hydroxy-terminated polyurethane prepolymer of the invention or of a composition of the invention with at least one chain extender, the chain extender preferably being a polyisocyanate.

The hydroxy-terminated polyurethane prepolymer of the invention or composition of the invention is preferably reacted with at least one chain extender to form a polyurethane polymer. When a polyisocyanate is used as the chain extender, all polyisocyanates known to those skilled in the art are suitable, preferably aliphatic polyisocyanates, aromatic polyisocyanates, cycloaliphatic polyisocyanates and araliphatic polyisocyanates. The reaction of the prepolymer with the chain extender to form the polymer can be carried out for example in an extruder.

A further object of the invention relates to an article comprising or containing a polymer of the invention, a hydroxy-terminated polyurethane prepolymer of the invention or a composition of the invention.

A further object of the invention relates to the use of a polymer of the invention for the production of shaped bodies, films and/or fibres.

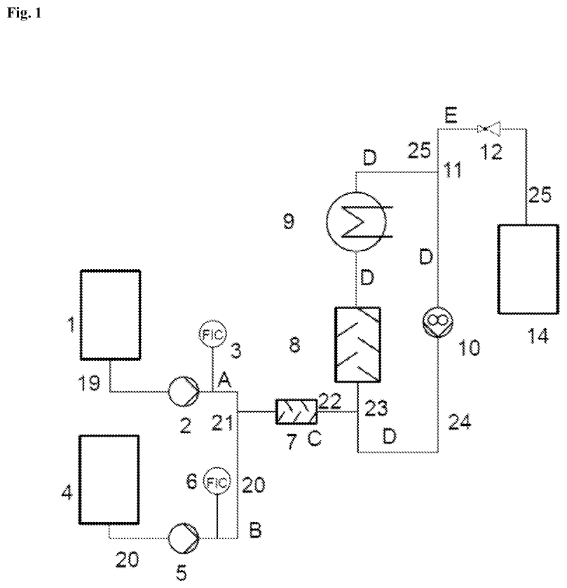

The present invention is more particularly elucidated hereinbelow with reference to FIGS. 1, 2 and 3. In these figures:

FIG. 1 shows a preferred apparatus for the execution of the process of the invention,

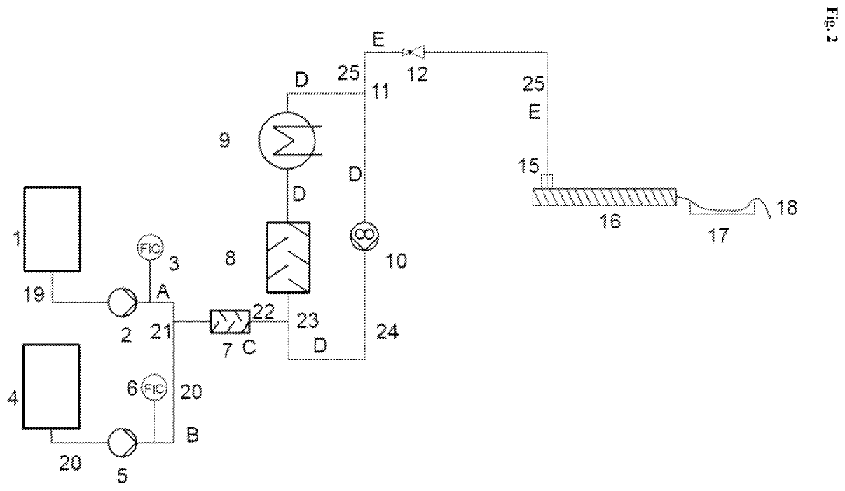

FIG. 2 shows a further preferred apparatus for the execution of the process of the invention,

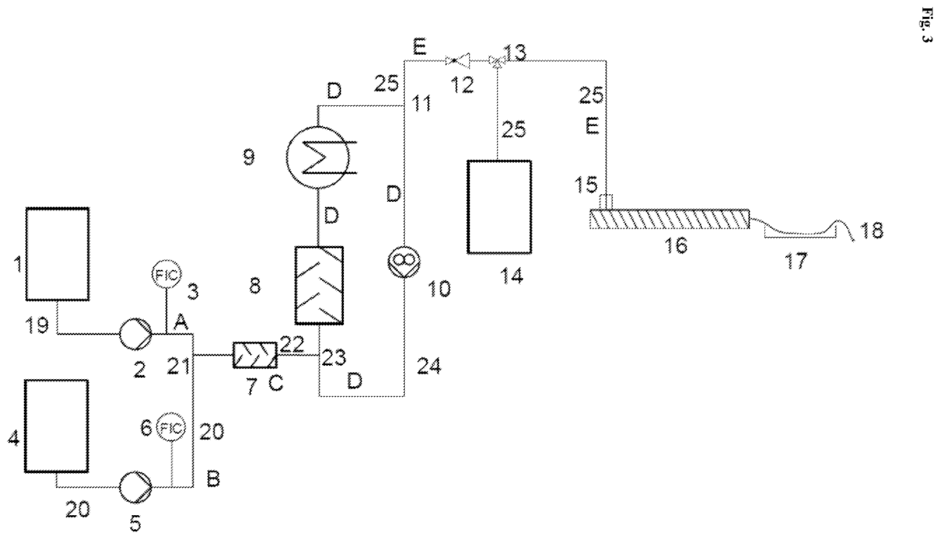

FIG. 3 shows a further preferred apparatus for the execution of the process of the invention.

### EXAMPLES

The present invention is elucidated further by the examples that follow, but without being restricted thereto.

### Colour Values

Colour values in the CIE-Lab colour space were determined with a Konica Minolta CM 2600d spectrophotometer with the D 65 illuminant, 10° observer, in accordance with DIN EN ISO 11664-1 (July 2011).

### Allophanate Content

The allophanate concentration was determined by ¹H NMR spectroscopy (instrument: Bruker AV III HD 600, at a measurement frequency of 600.36 MHz, using the zg30 pulse program, with 64 scans, a relaxation delay (D1) of 6 s and TE of 354 K). For this, a sample of the polyurethane prepolymer was dissolved in deuterated dimethyl sulfoxide (DMSO-d6) at 80° C. and then measured. Spectra were evaluated using the MestReNova software. Firstly, a baseline correction (Whittaker smoother) was applied, which was followed by integration of the allophanate-specific protons of the CH₂ group between 3.56 ppm and 3.66 ppm and of the urethane-specific protons of the O—CH₂ group between 3.84 ppm and 4.04 ppm. The sum of the two integrals was then calculated and used to determine the proportion by percent of the allophanate signal, which corresponds to the molar proportion of the allophanate groups.

### Gel-Permeation Chromatography

The molar masses of the polymers were determined by gel-permeation chromatography (GPC). For this purpose, the sample to be analyzed was dissolved in a solution of 3 g of potassium trifluoroacetate in 400 cubic centimetres of hexafluoroisopropanol (sample concentration about 2 mg/cubic centimetre). The respective GPCs were measured with the following components at a flow rate of 1 cubic centimetre/minute:
Pump: 515 HPLC pump (Waters GmbH)
Detector: Smartline 2300 RI detector (Knauer Wissenschaftliche Geräte GmbH)
Columns: 1 pre-column, 1000 Å PSS PFG 7 μm, 300 Å PSS PFG 7 μm, 100 Å PSS PFG 7 μm in the sequence specified
Degassing: PSS degasser (Polymer Standards Service GmbH)
Injection volume: 100 microlitres
Temperature: 23-25° C.
Molar mass standard: Polymethylmethacrylate standard kit (PSS Polymer Standards Service GmbH)

### Calculation of M̅_{z} and M̅_{w} and M̅ₙ

The centrifuge-average molar mass (M̅_{z}) was calculated from the data obtained by the gel-permeation chromatography measurement with the aid of the following equation:

$${\overline{M}}_{z} = \frac{{\sum }_{i} {n}_{i} {M}_{i}^{3}}{{\sum }_{i} {n}_{i} {M}_{i}^{2}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

The mass-average molar mass (M̅_{w}) was likewise calculated from the data obtained by the gel permeation chromatography measurement with the aid of the following equation:

$${\overline{M}}_{w} = \frac{{\sum }_{i} {n}_{i} {M}_{i}^{2}}{{\sum }_{i} {n}_{i} {M}_{i}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

The number-average molar mass (M̅ₙ) was likewise calculated from the data obtained by the gel-permeation chromatography measurement with the aid of the following equation:

$${\overline{M}}_{n} = \frac{{\sum }_{i} {n}_{i} {M}_{i}}{{\sum }_{i} {n}_{i}} in g / mol$$

where:

Mᵢ is the molar mass of the polymers of the fraction i, such that Mᵢ<Mᵢ₊₁ for all i, in g/mol, nᵢ is the molar amount of the polymer of the fraction i, in mol.

### Differential Scanning Calorimetry (DSC)

Melting points were determined by DSC (differential scanning calorimetry) using a DSC 8500 (PerkinElmer, USA) in accordance with DIN-EN-ISO 11357-1. Calibration was effected via the melt onset temperature of octane, indium, lead and zinc. About 10 mg of substance was weighed into aluminium crucibles. The measurement was effected by two heating runs from −20° C. to +210° C. at a heating rate of 20 K/min with subsequent cooling at a cooling rate of 20 K/min. Cooling was effected by a compressor cooler. The purge gas used was nitrogen. The values reported are each based on evaluation of the 2nd heating curve.

### I. Raw Materials Used

Hexamethylene 1,6-diisocyanate (HDI, purity ≥99% by weight) was obtained from Covestro Deutschland AG.

Butane-1,4-diol (BDO, purity ≥99% by weight) was obtained from Ashland.

### Example 1

Hexamethylene 1,6-diisocyanate (HDI) was conveyed at room temperature from a holding tank to a static mixer by means of a pump (stream A). Butane-1,4-diol (BDO) heated to approx. 40° C. was likewise conveyed from another holding tank to the continuous mixer by means of a pump (stream B). The throughput of the HDI stream A and of the BDO stream B was monitored by mass flow meters. In the mixer 7, the HDI stream A and the BDO stream B were mixed/dispersed to form the HDI/BDO dispersion (stream C).

The HDI/BDO stream C is combined and mixed in a mixer in circulation with a prepolymer stream D heated to 182° C. (stream E). The temperature of the prepolymer stream D causes a reaction between HDI and BDO, which is maintained by further mixing in a temperature-controllable mixer, with the formation of prepolymers and with dissipation of the heat of reaction. The temperature-controllable mixer is heated/cooled with heat-transfer oil and has a heat-exchange surface area of at least 0.31 m². The inflow temperature of the heating medium is approx. 180° C. An output stream is obtained from the temperature-controllable mixer in the form of a largely reacted HDI/BDO prepolymer stream having a temperature of 183° C. (stream E). The temperature-controllable static mixer was of similar construction to a Sulzer SMX reactor with internal crossed tubes. It had an internal volume of 2.2 litres and a heat exchange surface area of 0.31 square metres. Under the operating conditions, its heat-exchange capacity based on the product side was 78 watts per kelvin. Based on the total volume of the loop reactor of 4 litres, the heat-transfer coefficient was 19 kilowatts per cubic metre and kelvin. The amount of heat conducted away by the heat-transfer unit was approx. 890 watts. The ratio of heat-transfer surface area to total surface area was 0.655. The average OH functionality was exactly 2. Stream E is split at a branching point into two substreams F and G, substream F being fed back into the abovementioned mixer as prepolymer stream D by means of a pump, via pipelines heated to approx. 182° C. The mass flow of stream G corresponds to the mass flow of stream C. The mass flow of stream G was approx. 115 L/h. Substream G is collected in a 60 L drum and cooled. The resulting product is crystalline and white. The total amount of prepolymer produced is 50 kg. Colour index measurement gave an L value of 92.2, an a value of 0.7 and a b value of 1.7. The viscosity of the product at 190° C. was 0.7 Pa s.

In the inventive example, the following reactant streams were used:

| | | kg/h | mol/h |
|---|---|---|---|
| Stream A | HDI | 4.367 | 25.965 |
| Stream B | BDO | 3.000 | 33.289 |

The ratio of NCO groups in the polyisocyanate monomers to hydroxy groups in the polyol monomers was x=0.78. The degree of polymerization was n=3.55.

The allophanate content was determined to be 0.34%.

The average functionality of the monomers was 2.

M̅_{w} was determined as 10810 g/mol, M̅ₙ as 1404 g/mol, the ratio therefore being 7.7. M̅_{z} was 28940 g/mol and the ratio

$$\frac{{\overline{M}}_{z}}{{\overline{M}}_{w}} = 2.68 .$$

The melting point was 175.5° C.

The heat conducted away in the tubular reactor was approx. 57% of the total enthalpy of reaction released therein.

### Example 2

1.49 kg/h of HDI was conveyed from holding tank 1 to the mixer 1 by means of a pump 1 (mzr-7255 annular gear pump from HNP). 2.00 kg/h of BDO was at the same time conveyed from holding tank 2 to the same mixer by means of a pump 2 (mzr-7205 from HNP). The mixing of the two material streams in the mixer was at room temperature. The mixer used was a Sulzer SMX, diameter 6 mm, ratio of length to diameter L/D=10. The mixture was subsequently fed into the reactor 1, which had been heated to 150° C. (model: CSE-X/8G, Form G, internal diameter=21.0 mm, length=1000 mm, from Fluitec). The resulting prepolymer with a HDI:BDO ratio of 0.4:1.0 was then mixed in mixer 2 (Sulzer SMX, diameter 6 mm, ratio of length to diameter L/D=10) at 121.44° C. with hexamethylene 1,6-diisocyanate from holding tank 3 (1.49 kg/h; pump 3: mzr-7255 annular gear pump from HNP). The mixture was subsequently fed into the reactor 2 (model: CSE-X/8G, Form G, internal diameter=21.0 mm, length=1500 mm, from Fluitec), which had been heated to 182° C. The dwell time in reactor 2 was 6.5 min. The pipelines from reactor 1 to reactor 2 and from mixer 2 were trace heated to approx. 180° C. The temperature increase in the second heat-transfer unit was 37.93° C. The average caloric temperature in the inflow to the first reactor was 25° C. The caloric temperature during the second HDI addition was 121.44° C., for which cₚ(HDI 2)=1750.27 J/(kg·K) and cₚ(oligomer)=2000.00 J/(kg·K). The complex viscosity of the product at 10 Hz and 190° C. was 0.15 Pa s. The average OH functionality was 2.

The ratio of NCO groups in the polyisocyanate monomers to hydroxy groups in the polyol monomers is x=0.8. The average degree of polymerization is n=4.

The allophanate content was 0.35%.

M̅_{w} was determined as 4389 g/mol, M̅ₙ as 1677 g/mol, the ratio therefore being 2.62. M̅_{z} was determined as 8095 g/mol, the ratio therefore being

$$\frac{{\overline{M}}_{z}}{{\overline{M}}_{w}} = 1.84 .$$

The melting point was 173° C.

The heat conducted away in the tubular reactor was approx. 55% of the heat used.

### Non-Inventive Example

A Teflon beaker equipped with a stirrer was charged with 35.11 g of butane-1,4-diol, blanketed with nitrogen and heated to approx. 180° C. 55.02 g HDI was then added dropwise, with stirring, such that the temperature of the reaction mixture did not exceed 200° C. (approx. 45 min). This was accompanied by a pronounced rise in the viscosity of the mixture. The remaining 9.71 g of HDI was then added and the reaction mixture stirred for a further 30 min for complete reaction of the HDI. This was accompanied by a gradual rise in temperature to 211° C. and a further increase in viscosity too. The product was then cooled to room temperature and measured. The allophanate content was 1.2%. However, the presence in the sample of gel particles that were insoluble in DMSO-d6 (crosslinking) suggests that the allophanate content is higher still. As a consequence of the gel particles, GPC was not carried out.

### LIST OF REFERENCE SYMBOLS

(A) Polyisocyanate stream
(B) Polyol stream
(C) Mixture stream
(D) Circulation stream
(E) Prepolymer stream
(1) Polyisocyanate reservoir vessel
(2) First feed device
(3) First mass flow meter
(4) Polyol reservoir vessel
(5) Second feed device
(6) Second mass flow meter
(7) First mixing device
(8) Second mixing device
(9) Temperature-controllable mixing device
(10) Temperature-controllable feed device
(11) First junction
(12) Pressure-control valve
(13) Three-way valve
(14) Collecting vessel
(15) Venting device
(16) Extruder
(17) Cooling device
(18) Comminution device
(19) Polyisocyanate line
(20) Polyol line
(21) Second junction
(22) Circulation feed line
(23) First junction
(24) Circulation line
(25) Prepolymer feed line

1. A hydroxy-terminated polyurethane prepolymer, consisting to an extent of at least 90% by weight of the product of the reaction of hexamethylene 1,6-diisocyanate with butane-1,4-diol, based on the total mass of the hydroxy-terminated polyurethane prepolymer, and that the allophanate content of the hydroxy-terminated polyurethane prepolymer is ≤1.00 mol % based on the sum total of all urethane and allophanate groups in the hydroxy-terminated polyurethane prepolymer, in each case determined by NMR spectroscopy.

2. The hydroxy-terminated polyurethane prepolymer according to claim 1, wherein the average degree of polymerization n of the hydroxy-terminated polyurethane prepolymer is within a range from 1.5 to 19, the average degree of polymerization being
$$n = \frac{x}{1 - x} ,$$
where x is the ratio of the NCO groups in the polyisocyanate monomers to hydroxy groups in the polyol monomers.

3. The hydroxy-terminated polyurethane prepolymer according to claim 1, consisting to an extent of at least 96% by weight, preferably to an extent of at least 97% by weight of the product of the reaction of hexamethylene 1,6-diisocyanate with butane-1,4-diol, based on the total mass of the hydroxy-terminated polyurethane prepolymer.

4. The hydroxy-terminated polyurethane prepolymer according to claim 1, wherein the allophanate content of the hydroxy-terminated polyurethane prepolymer is within a range from 0.25 mol % to 1.00 mol % based on the sum total of all urethane and allophanate groups in the hydroxy-terminated polyurethane prepolymer, determined by NMR spectroscopy.

5. The hydroxy-terminated polyurethane prepolymer according to claim 1, wherein the hydroxy-terminated polyurethane prepolymer has an average OH functionality, calculated from the functionalities of the monomers, of 1.8 to 2.1.

6. The hydroxy-terminated polyurethane prepolymer according to claim 1, wherein the ratio M̅_{w}/M̅ₙ of the hydroxy-terminated polyurethane prepolymer is within a range from 2 to 20 where M̅ₙ is the number-average molar mass and M̅_{w} the mass-average molar mass, in each case determined by gel-permeation chromatography, the sample being dissolved in a solution of potassium trifluoroacetate in hexafluoroisopropanol having a concentration of 2 mg/cm³ and using a polymethyl methacrylate standard.

7. The hydroxy-terminated polyurethane prepolymer according to claim 1, wherein the hydroxy-terminated polyurethane prepolymer has a melting point of >150° C., determined by differential scanning calorimetry in accordance with DIN EN 61006 (November 2004).

8. A process for producing a hydroxy-terminated polyurethane prepolymer according to claim 1, wherein at least hexamethylene 1,6-diisocyanate is reacted with butane-1,4-diol, optionally in the presence of a catalyst and/or auxiliaries and additives, the molar NCO/OH ratio being within a range from 0.6:1.0 to 0.95:1.0.

9. The process according to claim 8, wherein the reaction is carried out in a tubular reactor, the tubular reactor having at least one heat-transfer unit that continuously conducts away heat.

10. The process according to claim 8, wherein the process is solvent-free.

11. A composition comprising at least one hydroxy-terminated polyurethane prepolymer according to claim 1 and butane-1,4-diol.

12. The composition comprising at least one hydroxy-terminated polyurethane prepolymer according to claim 1 and at least one additive.

13. Use of a hydroxy-terminated polyurethane prepolymer according to claim 1 or of a composition according to claim 11 for the production of thermoplastic polyurethane and/or thermoplastic polyurethane dispersions.

14. A polymer obtained by the reaction of at least one hydroxy-terminated polyurethane prepolymer according to claim 1 or of a composition according to claim 11 with at least one chain extender.

15. An article comprising a polymer according to claim 14, a prepolymer according to claim 1, or a composition according to claim 11.

16. Use of a polymer according to claim 14 for the production of shaped bodies, films and/or fibres.
